(19) United States
(12) Patent Application Publication
(10) Pub. No.: US 2024/0016700 A1
(43) Pub. Date: Jan. 18, 2024

(54) ACTIVE POLYMER LINER FOR INDUCTION SEAL, AND METHOD OF MAKING AND USING SAME

(71) Applicant: CSP Technologies, Inc., Auburn, AL (US)

(72) Inventors: James S. Hollinger, Auburn, AL (US); Thomas C. Stringer, Auburn, AL (US)

(21) Appl. No.: 18/462,125

(22) Filed: Sep. 6, 2023

Related U.S. Application Data
(63) Continuation of application No. PCT/US2022/072432, filed on May 19, 2022.
(60) Provisional application No. 63/201,924, filed on May 19, 2021.

(51) Int. Cl. A61J 1/14; B65D 41/04; B65D 51/20; B65D 51/24; B65D 51/30

(52) U.S. Cl. CPC A61J 1/1468; A61J 1/1418; B65D 41/045; B65D 51/20; B65D 51/244; B65D 51/30; B65D 2251/0015; B65D 2251/0093

(57) ABSTRACT

Induction seal liners for containers include active polymer compositions that function as active agents within the container during storage of products and which may be easily removed and discarded after opening the container. The active agents can include antioxidant or oxygen scavenging materials, anti-melanosic agents, desiccants, antimicrobial agents, odor reducing agents, and others. The induction seal liners herein extend the shelf life of products while affixed to the opening of a container. An induction seal for a container, the induction seal comprising: a mounting sheet; and an induction seal liner attached to a headspace-facing surface of the mounting sheet, the induction seal liner comprising an active polymer component including a multiphase polymer composition, wherein a mounting portion is located or exposed between an outer edge of the induction seal liner and an outer edge of the mounting sheet.

### CROSS-REFERENCE TO RELATED APPLICATION

The present application is a continuation of PCT/US2022/072432, filed May 19, 2022, and titled “ACTIVE POLYMER LINER FOR INDUCTION SEAL, AND METHOD OF MAKING AND USING SAME”, which claims priority to U.S. Provisional Application No. 63/201,924, filed May 19, 2021 and titled “ACTIVE POLYMER LINER FOR INDUCTION SEAL”, the disclosure of each is hereby incorporated by reference in its entirety.

### FIELD

The presently disclosed technology relates to seals for containers and optionally to an active polymer induction seal functioning as a liner for the purpose of prolonging shelf life (but not necessarily use life) and reducing odors, for example, of products stored within a container. Optionally, the liner is easily removed along with and upon removal of an induction seal.

### BACKGROUND

Induction seals are commonly used on containers to prevent leakage, to prevent or reduce contamination, to prevent tampering, and to increase the shelf life of a product stored within the container. Induction sealing keeps unwanted pollutants and pathogens from seeping into food products. Induction sealing is applied in various industries for preventing or reducing spoilage of products, including food and beverage products, pharmaceuticals, cosmetics, and others. One of the main challenges to the shelf life of such products is oxidation. Induction sealing assists in extending the freshness and shelf life of such products by providing a hermetically sealed environment within a container and minimizing exposure to pathogens, moisture, oxygen and other atmospheric gases from entering the container.

Commonly, the induction seal is in the form of a metallic foil layer, typically aluminum. The seal is supplied as a closure by the manufacturer to the bottler. A typical induction seal is multi-layered. Commonly, the top layer is a paper pulp layer that is generally spot-glued to the cap. The next layer is wax that is used to bond a layer of aluminum foil to the pulp. The bottom layer is often a polymer film laminated to the foil. After the cap or closure is applied, the container passes under an induction coil, which emits an oscillating electromagnetic field. During the induction sealing process, the container passes under the sealing head of the induction coil, the conductive aluminum foil liner is heated and melts the wax, which is absorbed into the paper pulp backing and releases the foil from the cap. The polymer film also heats and flows onto the lip of the container. When cooled, the polymer creates a bond with the container resulting in a hermetically sealed container. Conveyor induction systems are typically used in commercial packaging processes. Hand held induction sealing devices are also available.

For certain applications, capless induction sealing is used to apply a foil seal to a container without the need for a closure device. In this case, foil is supplied pre-cut or in a reel. Where supplied in a reel, foil is die cut and transferred onto the container neck. When the foil is in place, it is pressed down by the seal head, the induction cycle is activated and the seal is bonded to the container. These processes have been well developed and established for multitudes of products. It is estimated that induction sealing provides billions of dollars of savings every year in manufacturing worldwide as a result of reducing contamination and spoilage and preserving freshness and prolonging shelf life of products.

Currently, the interior environments of containers are also typically controlled by insertion into packages of sachets, canisters, gel packs, inserts, plugs and liners that contain preservatives, oxygen and moisture control agents and antimicrobial agents. The materials of these inserts often have a harmful effect on the product being stored in the container after some period of time. As such, in connection with storage of certain products, it is desired to remove the preservatives, oxygen and moisture control agents, and antimicrobial agents from the product package.

In certain circumstances, it may also be desirable to control the environment within a container during storage of a product, but not after the container has been opened. An easy means for removing the preservative material is desired. Alternative means for controlling interior environments of containers and packaging are also continuously desired, especially for imparting special properties within the container.

In view of the multitude of products that benefit from induction sealing, there is an ever continuing need for additional improvements in helping to control the interior environment of packaging containers.

### SUMMARY

In one embodiment, the presently disclosed technology relates to seal liners, and optionally induction seal liners, that can include one or more active polymer compositions or components that function as and/or include active agents within the container during storage of products while affixed to the opening of a container.

Optionally, the induction seal liners herein include one or more active agents, such as but not limited to antioxidant or oxygen scavenging materials, anti-melonosic agents, desiccants, antimicrobial agents, odor reducing agents, and other agent capable of causing extension to the shelf life of products.

Optionally, the induction seal liners may be easily removed and discarded after opening the container.

Optionally, the active agents contribute to preservation of contents of a container (e.g., shelf life) prior to the first use or opening of the container.

Optionally, the active agents do not contribute to the use life of the contents of a container after the first use or opening of the container.

Optionally, the active polymer composition or component is molded.

Optionally, the active polymer composition is attached to the seal liner by at least one of adhesive or the application of heat.

In another optional embodiment, the presently disclosed technology is directed to an active polymer component attached to an induction seal of a container. The active polymer component can be attached to the induction seal by at least one of adhesive, heat sealing, and heat staking.

In another optional embodiment, the presently disclosed technology is directed to an induction seal for a container. The induction seal can include a mounting sheet and an induction seal liner attached to a headspace-facing surface of the mounting sheet. The induction seal liner can include an active polymer component including a multiphase polymer composition. A mounting portion can be located or exposed between an outer edge of the induction seal liner and an outer edge of the mounting sheet.

### BRIEF DESCRIPTION OF THE DRAWINGS

The following detailed description of the presently disclosed technology will be better understood when read in conjunction with the appended drawings. For the purpose of illustrating the presently disclosed technology, there are shown in the drawings various illustrative embodiments. It should be understood, however, that the presently disclosed technology is not limited to the precise arrangements and illustrations shown. The invention will be described in conjunction with the following drawings in which like reference numerals designate like elements. The terminology used herein is for the purpose of description and not of limitation.

FIG. 1 is a schematic side perspective view of an exemplary induction seal liner or a portion thereof of the presently disclosed technology.

FIG. 2 is a schematic side perspective view of an active polymer film for use in the induction seal liner in accordance with an embodiment of the presently disclosed technology.

FIG. 3 is a cross section of FIG. 1 taken along line II-II of FIG. 1.

FIG. 4 is a close-up view of a cross section similar to that of FIG. 3, of an optional embodiment of an induction seal liner of the presently disclosed technology showing uptake of a selected material by an active agent (arrows) according to the presently disclosed technology.

FIG. 5 is a schematic illustration of at least a portion of an active induction seal liner adhered to the underside of a metallic induction seal according to an optional embodiment of the presently disclosed technology.

FIG. 6 is a perspective view of an induction seal liner attached to a mounting sheet of one embodiment of the presently disclosed technology.

FIG. 7 is an exploded perspective view of a container and induction seal showing individual components including the induction seal liner of the presently disclosed technology.

FIG. 8 is perspective view of a container with a multi-layer induction seal including the induction seal liner of one embodiment of the presently disclosed technology.

FIG. 9 is a cross-sectional exploded view of a top section of the container taken along cutting plane IX-IX in FIG. 8, with a threaded closure positioned above the body of the container with an induction seal liner positioned between the mouth of a container and a removable induction seal in accordance with one embodiment of the presently disclosed technology.

FIG. 10 is a cross-sectional exploded view of the container taken along cutting plane IX-IX in FIG. 8, with an extended-release coating superimposed onto an induction seal liner in accordance with one embodiment of the presently disclosed technology.

FIG. 11 is a cross-sectional view of the container taken along plane IX-IX in FIG. 8, with the closure (cap) positioned on the opening of the container in accordance with one embodiment of the presently disclosed technology.

### DETAILED DESCRIPTION

### Definitions

As used herein, the term “absorption” refers to the physical or chemical phenomenon or process in which atoms, molecules or ions enter a liquid or solid material. Absorption is a condition in which the absorbate is dissolved by or permeates a liquid or solid (the absorbent), respectively. Absorption involves the volume of the material.

As used herein, the term “adsorption” refers to the adhesion of atoms, ions or molecules from a gas, liquid or dissolved solid to a surface. The adsorption process creates a film of the adsorbate on the surface of the adsorbent. Adsorption is a surface phenomenon. In the process of absorption, the molecules undergoing absorption are taken up by the volume, not by the surface; whereas in adsorption, the molecules undergoing adsorption are taken up by the surface.

As used herein, the term “active” is defined as capable of acting on, interacting with or reacting with a selected material (e.g., moisture or oxygen) according to the invention. Examples of such actions or interactions may include absorption, adsorption or release of the selected material. Another example of “active”, which is pertinent to a primary focus of the present invention is an agent capable of acting on, interacting with or reacting with a selected material in order to cause release of a released material.

The term “active agent” as used herein, is defined as a material that acts on, interacts with or reacts with one or more selected materials. The term “active agent” may include but is not limited to materials that absorb or adsorb or a selected material. The term “active agent” as used herein also encompasses active forming agents or active releasing agents that form and release an active compound.

The term “antimicrobial agent” as used herein refer to a compound that forms or releases antimicrobial gas(es) that inhibit growth or proliferation of microorganisms. Classes of antimicrobial agents include antiviral, antibacterial, antifungal, antiparasitic and other anti-pathogenic substances.

The term “base polymer” as used herein is a polymer used according to the invention that is capable of being formed with the channeling agents and active forming agents herein, and optionally having a gas transmission rate of a selected material that is substantially lower than, lower than or substantially equivalent to, that of a channeling agent. By way of example, such a transmission rate is a water vapor transmission rate in embodiments where the active forming agent is activated by moisture. The primary function of the base polymer is to provide structure for the polymer composition.

The term “channeling agent” as used herein is defined as a material that is immiscible with the base polymer and has an affinity to transport a gas phase substance at a faster rate than the base polymer alone. Optionally, a channeling agent is capable of forming channels through the base polymer when formed by mixing the channeling agent with the base polymer. Optionally, such channels are capable of transmitting a selected material, such as water, aldehyde or others, through the entrained polymer at a faster rate than in solely the base polymer.

The terms “channel(s)” or “interconnecting channel(s)” as used herein refer to passages formed of the channeling agent that penetrate through the base polymer and the channels may be interconnected with another.

The terms “container” or “package” as used herein, are used interchangeably, and refer to a receptacle capable of holding an object, wherein the walls of the container form an interior space within and enclosed by the walls and having an opening for placing an object into the interior space.

The term “desiccant” as used herein refers to a substance that absorbs water (in the form of moisture, vapor, gas or water molecules.)

The term “headspace” as used herein refers to any portion of empty space within an interior of a container whereby, when an object is contained in the container, the headspace forms and surrounds the object within the interior space of the container that is not occupied by the object.

The term “induction sealing” as used herein refers to the process of bonding thermoplastic materials, (e.g., polymer compositions), by induction heating.

The term “induction seal” as used herein refers to the seal formed of a thermoplastic material covering the opening of a container, typically bonded by induction heating to the rim or lip of the container wall that extends around the perimeter of the opening.

The term “induction seal liner” as used herein refers to an entrained polymer composition according to the invention in the form of a film or sheet and forming all or part of the induction seal of a container.

The term “monolithic,” as in “monolithic composition” refers to a substance that is made of one essentially admixed or blended composition of materials, such that the composition does not itself consist of two or more discrete macroscopic layers or portions. Accordingly, a monolithic composition does not include a multi-layer composite, although a monolithic composition could form a layer of such a composite. The monolithic material of the polymer composition herein is formed of at least a base polymer with an active agent (or active forming/releasing agent) and/or with a channeling agent that are distributed or entrained throughout the base polymer.

The term “oxygen scavenger” as used herein refers to a compound, composition or material which can remove or reduce oxygen or refers to a compound which can control the level of oxygen within a defined space, such as a fully closed or substantially closed container. “Oxygen scavenging”, “oxygen regulating” and “oxygen control” are used interchangeably herein. Generally, an oxygen scavenging compound may also function as an “antioxidant”, a substance that inhibits oxidation and refers to a material or compound which slows the rate of oxidation or otherwise reduces the undesirable effects of oxidation on a product or object, such as a foodstuff, beverage, cosmetic, pharmaceutical, tobacco, cannabis, chemical agents and other substances and other products.

The term “phase” as used herein refers to a portion or component of a monolithic composition that is distributed throughout, preferably but not necessarily distributed uniformly, to give the structure or composition of the polymer composition its monolithic characteristic. Herein, a two-phase formulation comprises a base polymer and an active agent, (without a channeling agent); and a three-phase formulations comprises a base polymer, an active agent and a channeling agent. Optionally, the two- or three-phase compositions may include additional compounds, (e.g., colorants, plasticizers, antimicrobial agents, etc.), but are nonetheless still considered “two-phase” or “three-phase”, respectively, on account of the presence of the primary functional components.

The term “polymer composition” as used herein refers to a monolithic material formed of at least one base polymer and an active agent, and optionally, also a channeling agent distributed throughout the base polymer. As described above, the polymer compositions according to embodiments of the invention thus includes both two-phase polymer compositions and three-phase polymer compositions.

The term “sorption” encompasses both processes of absorption and adsorption, as well as the process of ion exchange. According to the invention, the terms “absorption”, “adsorption” and “sorption” are used interchangeably herein.

### Seal Liners and Induction Seal Liners

The seal liners and induction seal liners used in accordance with the presently disclosed technology are disposed onto or affixed onto and/or over the opening of a container. According to the presently disclosed technology, the seal liners and induction seal liners herein impart desired properties to the interior space, and particularly to the headspace within a container. The seal liners and induction seal liners herein can include polymer compositions that contain one or more active agents in either a two-phase or three-phase entrained polymer compositions. In optional embodiments, the active agent(s) entrained in the polymer compositions herein may form and release active compounds. In other optional embodiments, the active agent(s) herein may act by sorption of ambient air or volatile compounds found within a container or package or that are formed and released by an object contained in the container or package.

The use of the seal liners and induction seal liners in the presently disclosed technology is not limited. The seal liners and induction seal liners herein may be used in packaging of any types and forms of substances, including liquids, solids, powders, creams, gels, or any combinations thereof. The seal liners and induction seal liners herein may be used on containers for storage of any of a variety of products such as, but not limited to, pharmaceutical and nutraceutical products, medicinal and dental products, foods and beverages, cosmetics, health and beauty products, automotive petroleum products, chemical products, household cleaning agents (ex. detergents, degreasers, abrasives or acidic, alkaline or neutralizing agents), agricultural and agrichemical products, animal care and medicinal products, sporting goods supplies, hunting and fishing products, children's toys (e.g., clays, bubbles), paints and paint related products (e.g., adhesives, pastes, sealants, stains), home remodeling products, musical instrument supplies, cleaners, resins, lubricants, computer products (e.g., inks, dyes, carbon products), manufacturing supplies, school supply products and myriad of others.

The methods of producing the polymer compositions that form the seal liners and/or the induction seal liners according to the presently disclosed technology are not limited. The polymer compositions used herein can be prepared by both common and specialized manufacturing processes such as extrusion, injection molding, blow molding, thermoforming, vacuum molding, casting, continuous compounding and hot melt dispensing using standard equipment, some of which are generally well known. Optionally, the polymer compositions herein are extruded as films and/or sheets that are made of layers of film. The polymer film/sheet may be either totally or partially clear, tinted or opaque. The size and thickness of the film/sheet can vary. Optionally, the film or sheet may range from 0.1 mm to 1.0 mm, more preferably from 0.2 mm to 0.6 mm. In certain embodiments, the film or sheet has a thickness of approximately 0.2 mm or 0.3 mm.

In the process of manufacture, the active agent is added to one or more base polymers, and optionally, with one or more channeling agents, and the compounds are combined and generally admixed or blended with one another to some degree. The active agent is optionally immiscible with the base polymer and when mixed and heated with the base polymer and the channeling agent, will not melt, i.e., has a melting point that is higher than the melting point for either the base polymer or the channeling agent. The active agent may be added to the base polymer in powder or liquid form, depending on the compound. The produced combination of the base polymer mixed with the active agent becomes an entrained polymer composition. The entrained polymer compositions are composed of generally monolithic material having an essentially uniform composition formed of at least a base polymer, the active agent and optionally, one or more channeling agents entrained or distributed throughout.

An entrained polymer thus can optionally include at least two phases (the base polymer and active agent, without a channeling agent) or at least three phases (base polymer, active agent and a channeling agent). In optional embodiments, the active agent may be uniformly or essentially uniformly distributed within the base polymer such that the entrained polymer composition becomes homogeneous or essentially homogeneous but the active agent does not need to be distributed uniformly throughout. Entrained polymer compositions are further described, for example, in U.S. Pat. Nos. 5,911,937, 6,080,350, 6,124,006, 6,130,263, 6,194,079, 6,214,255, 6,486,231, 7,005,459, and U.S. Patent Publication No. 2016/0039955, each of which is incorporated herein by reference as if fully set forth herein.

In optional embodiments, the concentration of the base polymer within the polymer composition is in a range from 10% to 80%, optionally from 20% to 70%, optionally from 30% to 60%, optionally from 40% to 50%, optionally from 45% to 65%, optionally from 45% to 60%, optionally from 45% to 55%, optionally from 50% to 70%, optionally from 50% to 60%, optionally from 55% to 65%, optionally from 55% to 60% by weight of the total weight of the entrained polymer composition.

Suitable base polymer materials include thermoplastic polymers including but not limited to, polypropylene, polyethylene, polyoxmethylene, polylactic acid (PLA), polyolefins such as polypropylene and polyethylene, olefin copolymers, polyisoprene, polybutadiene, acrylonitrile butadiene styrene (ABS), polybutene, polysiloxane, polyhydroxyalkanoate (PHA), polycarbonate, polyamides, polybutylene succinate (PBS), ethylene-vinyl acetate copolymer, ethylene-methacrylate copolymer, polyvinyl chloride (PVC), polystyrene, polyesters, polyanhydrides, polyacrylianitrile, polysulfones, polyacrylic ester, acrylic, polyurethane, polyacetal, polyhexene, polyvinylpyrrolidone (PVP), a copolymer, and combinations thereof. In one optional embodiment, the package or container is composed of a rigid or semi-rigid polymer, optionally polypropylene or polyethylene, and preferably has sufficient rigidity to retain its shape under gravity.

The channeling agents of the entrained polymer form channels between the surface of the polymer composition and its interior in order to transmit moisture or gas, to absorb or adsorb moisture or gas, and/or to allow reaction of moisture or gas with the active agent component in order to form and release active compound or to effectuate uptake of the moisture or gas. The channels are mainly formed of the channeling agent itself. Embodiments of a channeling agent useful herein have a water vapor transmission rate of at least two times that of the base polymer. In other embodiments, the channeling agent has a water vapor transmission rate of at least five times that of the base polymer. In other embodiments, the channeling agent has a water vapor transmission rate of at least ten times that of the base polymer. In still other embodiments, the channeling agent may have a water vapor transmission rate of at least twenty, fifty or one hundred times that of the base polymer.

Suitable channeling agents of the entrained polymer compositions operable herein include polyglycol such as polyethylene glycol (PEG), ethylene-vinyl alcohol (EVOH), polyvinyl alcohol (PVOH), glycerin polyamine, polyurethane and polycarboxylic acid including polyacrylic acid or polymethacrylic acid. Alternatively, the channeling agent can be, for example, a water insoluble polymer, such as a polypropylene oxide-monobutyl ether, polyethylene glycol, which is commercially available under the trade name Polyglykol B01/240; polypropylene oxide monobutyl ether, which is commercially available under the trade name Polyglykol B01/20; and/or polypropylene oxide, which is commercially available under the trade name Polyglykol D01/240, all produced by Clariant Specialty Chemicals Corporation. Other embodiments of channeling agents comprise ethylene vinyl acetate, nylon 6, nylon 66, or any combination of the foregoing. optionally from 10% to 12% by weight with respect to the total weight of the entrained polymer.

In alternate embodiments, the concentration of the channeling agent in the polymer composition is in a range from 1% to 25%, optionally from 2% to 15%, optionally from 5% to 20%, optionally from 8% to 15%, optionally from 10% to 20%, optionally from 10% to 15%, optionally from 10% to 12%, optionally from 5% to 15%, optionally about 7% by weight of the total weight of the polymer composition.

Optionally, within embodiments of polymer induction seal liners according to the presently disclosed technology, the active agent loading level is in an amount or concentration sufficient to be effective to impart a particular property into the headspace of the container. Preferably, the concentration of the active agent in the entrained polymer composition ranges from to 70%, optionally from 5% to 60%, optionally from 10% to 50%, optionally from 20% to 40%, optionally from 30% to 35% by weight with respect to the total weight of the polymer composition with the loading of the base polymer, optionally, the channeling agent, and optionally other additives such as colorants, plasticizers, antimicrobial agents or preservatives, forming the remainder of the polymer composition. The amount of the active component will be chosen according to the properties desired in a particular packaging application, for example, the amount of oxygen control desired for an oxygen controlled container.

Optionally, the entrained polymer within the induction seal liners may be a two phase formulation including 20% to 70% by weight of the active agent, preferably in powder form, 30% to 80% by weight a base polymer (such as polyethylene, polyethylene-based copolymer, polypropylene, ethylene vinyl acetate (EVA), or a mixture). The base polymer is not particularly limited. Optionally, an entrained polymer may be a three phase formulation including 20% to 60% by weight, preferably in a powder form, 30% to 70% by weight a base polymer, and 2-15% by weight a channeling agent. The base polymer and the channeling agent are not particularly limited.

Suitable active agents of primary focus in this specification, include but are not limited to antioxidants, (also known as or referred to as oxygen scavenging compounds); desiccants (typically hygroscopic substances that are used as a drying agent); antimicrobial agents (such as antibacterials, antivirals, antifungals and others); odor reducing agents; anti-melanosic agents and other functional substances, compounds or materials that may be incorporated into polymer compositions for use in induction seal liners according to the invention are contemplated.

Oxygen scavenging materials for use in the induction seal liners of the invention include, but are not limited to, oxidizable polymers, ethylenically unsaturated polymers, benzylic polymers, allylic polymers, polybutadiene, poly[ethylene-methyl-acrylate-cyclohexene acrylate] terpolymers, poly[ethylene-vinylcyclohexene] copolymers, polylimonene resins, poly beta-pinene, poly alpha-pinene and a combination of a polymeric backbone, cyclic olefinic pendent groups and linking groups linking the olefinic pendent groups to the polymeric backbone. Additional oxygen scavenging agents include polycarboxylic or salicylic acid chelate or complexes. In optional embodiments, metal salts may be further incorporated into the induction seal polymer liners. In yet further optional embodiments, photoinitiators may be incorporated in order to further catalyze the oxygen scavenging properties of such materials.

Common desiccants operable with the seal liners and induction seal liners of the presently disclosed technology include, but are not limited to, activated alumina, aerogel, benzophenone, bentonite clay, calcium chloride, calcium oxide, calcium sulfate, cobalt(II) chloride, copper(II) sulfate, lithium chloride, lithium bromide, magnesium chloride hexahydrate, magnesium sulfate, magnesium perchlorate, molecular sieve, phosphorus pentoxide, potassium carbonate, potassium hydroxide, silica gel, sodium, sodium chlorate, sodium chloride, sodium hydroxide, sodium sulfate, sucrose, and sulfuric acid, among others, and may be incorporated into the polymer compositions herein to form the induction seal liners of the invention.

According to an alternate embodiment, rather than incorporating the active agent directly into or onto a base polymer, the active agent may also be combined with, suspended in, or otherwise incorporated into an absorbent material directed to and suitable for absorbency of liquids, moisture or gases in the polymer film in order to enhance its functional properties. For example, the active agent, e.g., oxygen scavenger can be combined directly with an absorbent matrix material.

An example of such a matrix material is an adsorbent composition of matter as disclosed in U.S. Pat. No. 6,376,034, which is incorporated by reference herein in its entirety. The absorbent composition of matter or “absorbent packet” used interchangeably herein, has an absorbency, the absorbency being defined by weight of liquid absorbed/weight of the absorbent composition of matter. The absorbent composition of matter includes the following: (i) at least one non-crosslinked gel-forming water soluble polymer having a first absorbency, the first absorbency being defined by weight of liquid absorbed/weight of the at least one non-crosslinked gel forming polymer, the at least one non-crosslinked gel forming polymer being food safe; and (ii) at least one mineral composition having a second absorbency, the second absorbency being defined by weight of liquid absorbed/weight of the at least one mineral composition, the at least one mineral composition being food safe, the absorbency of the absorbent composition of matter exceeding a sum of the first absorbency and the second absorbency, the absorbent composition of matter being compatible with food products such that the absorbent composition of matter is food safe when in direct contact with the food products. Optionally, the absorbent composition of matter includes additionally: (iii) at least one soluble salt having at least one trivalent cation, the at least one soluble salt having at least one trivalent cation being food safe.

The absorbent material contains from about 10 to 90% by weight, preferably from about 50 to about 80% by weight, and most preferably from about 70 to 75% by weight of a non-crosslinked gel forming polymer. The non-crosslinked gel forming polymer can be a cellulose derivative such as carboxymethylcellulose (CMC) and salts thereof, hydroxyethylcellulose, methylcellulose, hydroxypropylmethylcellulose, gelatinized starches, gelatin, dextrose, and other similar components, and may be a combination of the above. Certain types and grades of CMC are approved for use with food items and are preferred when the absorbent is to be so used. The preferred polymer is a CMC, most preferably sodium salt of CMC having a degree of substitution of about 0.7 to 0.9. The degree of substitution refers to the proportion of hydroxyl groups in the cellulose molecule that have their hydrogen substituted by a carboxymethyl group. The viscosity of a 1% solution of CMC at 25° C., read on a Brookfield viscometer, should be in the range of about 2500 to 12,000 mPa.

The clay ingredient in the matrix material can be any of a variety of materials and is preferably attapulgite, montmorillonite (including bentonite clays, such as hectorite), sericite, kaolin, diatomaceous earth, silica, and other similar materials, and combinations thereof. Preferably, bentonite is used. Bentonite is a type of montmorillonite and is principally a colloidal hydrated aluminum silicate and contains varying quantities of iron, alkali, and alkaline earths. The preferred type of bentonite is hectorite which is mined from specific areas, principally in Nevada. Diatomaceous earth is formed from the fossilized remains of diatoms, which are structured somewhat like honeycomb or sponge. Diatomaceous earth absorbs fluids without swelling by accumulating the fluids in the interstices of the structure.

Optionally, a soluble salt is provided in order to render a trivalent cation. The soluble salt is optionally derived from aluminum sulfate, potassium aluminum sulfate, and other soluble salts of metal ions such as aluminum, chromium, and the like. Preferably, the trivalent cation is present at about 1 to 20%, most preferably at about 1 to 8%. The inorganic buffer is one such as sodium carbonate (soda ash), sodium hexametaphosphate, sodium tripolyphosphate, and other similar materials. If a buffer is used, it is present preferably at about 0.6%, however beneficial results have been achieved with amounts up to about 15% by weight.

The combination of the non-crosslinked gel forming polymer, trivalent cation, and clay forms an absorbent material which when hydrated has an improved gel strength over the non-crosslinked gel forming polymer alone. Further, the gel exhibits minimal syneresis, which is exudation of the liquid component of a gel. In addition, the combined ingredients form an absorbent which has an absorbent capacity which exceeds the total absorbent capacity of the ingredients individually. The active agent may function to further enhance the moisture absorbing characteristics of the absorbent material.

Various plasticizers or dispersants may be used as additives to the base polymer or polymer compositions herein to modify the plasticity or modify the viscosity of the base polymer which will affect the size of the channeling agents. Plasticizers are relatively non-volatile organic substances and will typically be added in manufacturing to the base polymer in the form of a liquid, to modify the flexibility, extensibility and/or processability of the polymer composition, which desired characteristics will be determined by the desired end-use application. Non-limiting general chemical families of common plasticizers useful for polymer modification include: phthalate esters, most commonly, DEHP, (low molecular weight ortho-phthalate) and is the most widely used PVC plasticizer, and DINP, DIDP (high molecular weight ortho-phthalates); aliphatic dibasic acid esters, including glutarates, adipates, azelates and sebecates; benzoate esters; trimellitate esters; polyesters; citrates; bio-based plasticizers, such as epoxidized soybean oil (ESBO), epoxidized linseed oil (ELO), castor oil, palm oil, other vegetable oils, starches and sugars; phosphates; chlorinated paraffins; alkyl sulfonic acid esters and others.

Plasticizers such as dimers may be used herein to enhance the compatibility between the base polymer and the channeling agent. This enhanced compatibility is facilitated by a lowered viscosity of the blend, which may promote a more thorough blending of the base polymer and channeling agent, which under normal conditions can resist combination into a uniform solution. For example, upon solidification of the entrained polymer having a dimer agent added thereto, the interconnecting channels which are formed throughout the base polymer have a greater dispersion and a smaller porosity, thereby establishing a greater density of interconnecting channels throughout the polymer composition.

In alternate embodiments, the seal liners and induction seal liners can include an antioxidant active agent. In such embodiments, contact of the seal liner and/or induction seal liner with moisture or liquid within the interior of the container initiates an oxygen scavenging reaction of the antioxidant component. Optionally, and/or in addition to oxygen control, the induction seal liner polymer film can include a desiccant to effectuate sorption (by absorption or adsorption) of any ambient moisture within the container. Oxygen and moisture control within the container will increase shelf life and reduce odor production of certain products. Products stored in the container which exude moisture, such as gels, lotions, creams, liquids, will initiate the oxygen scavenging and desiccant properties of such liners. Other products that exude moisture may be stored in the container, which may emanate moisture from the product into the headspace of the container and onto the oxygen or desiccant control induction seal liners. The induction seal liner is removed and discarded when the product is ready for use.

In certain embodiments, a controlled release or a desired release profile can be achieved by applying a coating to the active agent or onto the polymer film or sheet, such as for example, a spray coating wherein the coating is configured to release the active forming component within a desired time frame. Different coatings may be applied to achieve different release effects. For example, the polymer liner film may be coated with extended release coatings of varying thicknesses and/or properties to achieve the desired release profile. For example, some active agent will be coated such that the polymer induction seal liner will begin oxygen scavenging, desiccation, antimicrobial activity or other functionality immediately, while other coating agents will begin activity after days or weeks after being affixed in the container.

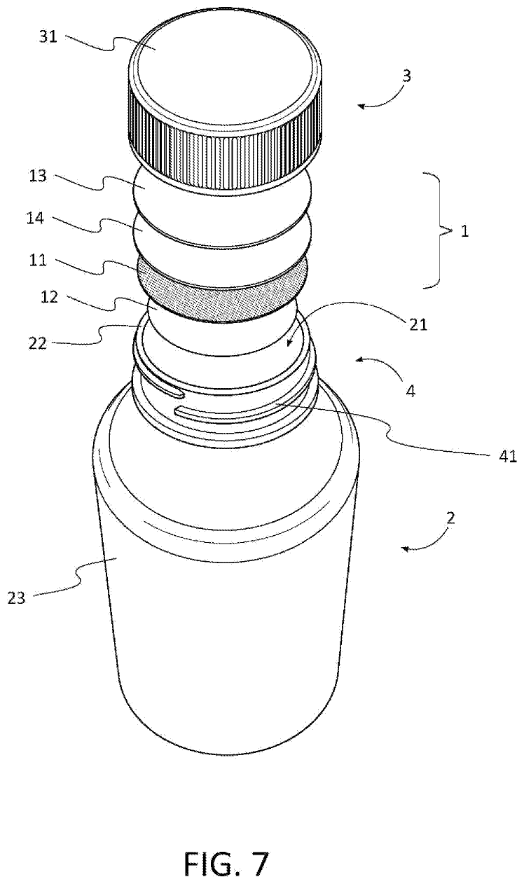

Referring to FIG. 7, a seal or induction seal 1 and a seal liner or an induction seal liner 12 attached thereto described herein are intended to be secured or affixed directly to the mouth or opening 21 of a container 2. Optionally, the seal liner or the induction seal liner 12 can be secured or affixed and provided to the container 2 separately from, i.e., without the induction seal 1. According to such an embodiment, the seal liner or the induction seal liner 12 may be secured or affixed directly to the rim 22 that forms the perimeter of the opening 21 of the container 2 as a standalone induction seal.

In one optional embodiment, the seal liner 12 or the induction seal liner 12 is a molded component that includes or is an active polymer component.

Although induction sealing is preferred according to the presently disclosed technology for affixing or securing the induction seal 1 to the rim 22 of a container 2, the seal liner or the induction seal liner 12 may also be secured to a container 2 during packaging using a variety of processes including but not limited to, bonding with adhesives or lidding sealant, and heat sealing, heat staking or by direct in-line melt adhesion process, (e.g., as taught in published Application Nos. WO 2018/161091 and WO 2019/172953, each of which is incorporated by reference herein in its entirety.)

Alternatively, the seal liner or the induction seal liner 12 herein can be provided as part of the seal or the induction seal 1. In such embodiment, the seal liner 12 is affixed to at least a portion of or to the entire surface area of the underside of a mounting panel 11, which may be a metallic (e.g., aluminum) foil induction seal 1, as a separate layer on the induction seal 1. The thickness of a typical metallic foil 11 of an induction seal is in the range of 10 μm-100 μm, optionally 10 μm-80 μm, optionally 10 μm-60 μm, optionally 20 μm-50 μm, optionally 20 μm-30 μm.

### Reference to Figures

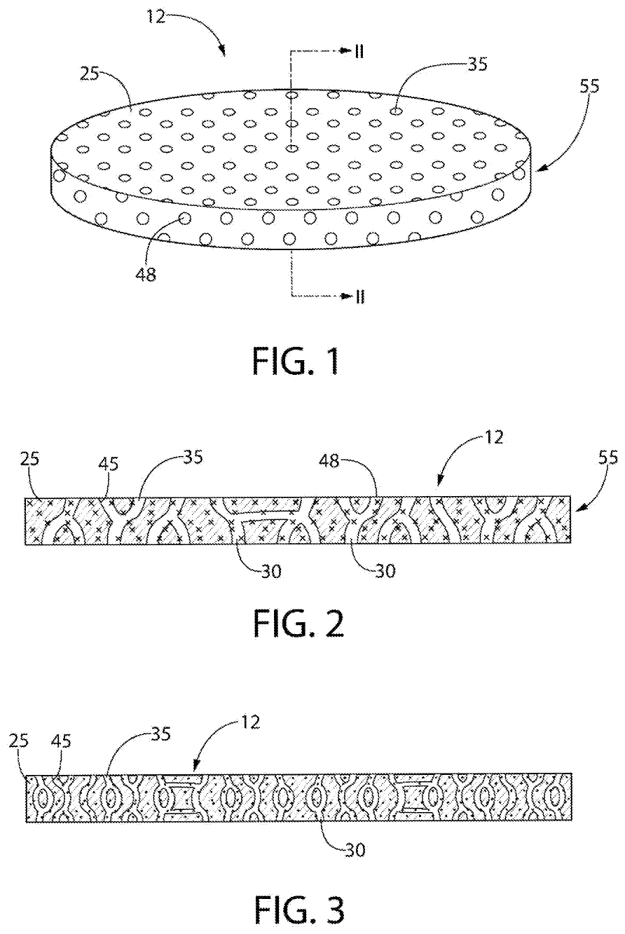

FIG. 1 shows a perspective view of a seal liner or an induction seal liner 12 in the form of a film 55 that has been constructed from an entrained polymer including the base polymer 25 that has been uniformly blended with an active agent 30 and the optional channeling agent 35 in order to form an embodiment of an induction seal liner 12 herein. In the illustration of FIG. 1, the polymer composition has been solidified so that interconnecting channels 45 have formed throughout the polymer composition to establish passages throughout the film 55. FIG. 2 further illustrates an embodiment of a seal liner or an induction seal liner 12. The arrows indicate the path of moisture from the exterior of the entrained polymer composition film 55, through the channels 45 within a base polymer 25, to the molecules of the active agent 30, which absorb or adsorb the moisture, gas or other compound. The interconnecting channels 45 facilitate transmission of the moisture, gas or other compound through the base polymer 25. As may be appreciated from both FIG. 1 and FIG. 2, the passages terminate in channel openings 48 at exterior surfaces of the film 55 creating more surface area for moisture, gas or other compounds or active agents to penetrate from and to the environment surrounding the induction seal liner 12. FIG. 3 illustrates an optional embodiment of a seal liner or an induction seal liner 12 showing smaller and more compact interconnecting channels 45 formed by channeling agents 35 throughout a base polymer 25 and entrained with active agent 30.

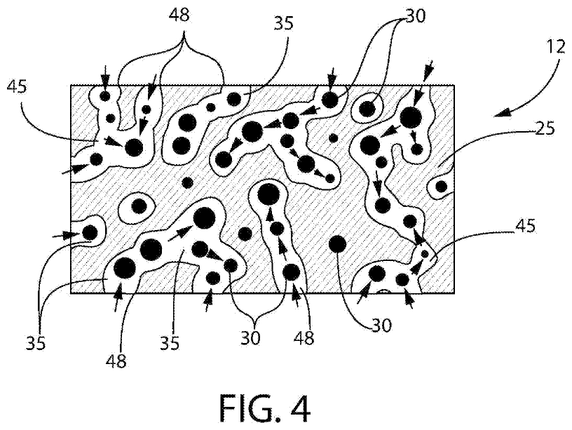

FIG. 4 illustrates a close-up view of a seal liner or an induction seal liner 12 with a base polymer 25 according to an optional embodiment of the presently disclosed technology, with an active agent 30. The arrows indicate the path of a selected material, for example moisture or gas, from an exterior of the seal liner or the induction seal liner 12, through the channels 45, to the particles of active agent 30. Optionally, the active agent reacts with or is otherwise triggered or activated by a selected material (e.g., by moisture) and in response releases an active component, optionally in gas or volatile form. Alternatively, the active agent 30 may itself function as, or release, an active component without the need for any triggering or activation, e.g., in a dry environment.

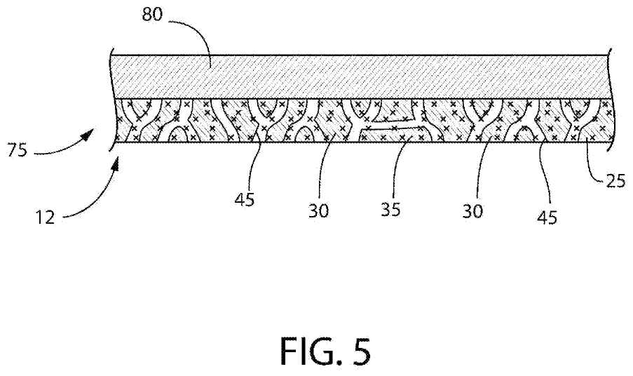

FIG. 5 illustrates an embodiment of a seal liner or an induction seal liner 12 in the form of an active sheet or film 75 formed of the entrained polymer and affixed to the underside of an induction seal 80. The characteristics of the active film or sheet 75 of the induction seal liner are similar to those described in FIGS. 1-4. The induction seal 80 would typically comprise a metallic foil layer (not illustrated) configured to bond to the induction seal liner 12.

Referring generally to FIGS. 1-11, the presently disclosed technology can include a seal or an induction seal 1 with an active polymer component induction seal liner 12 attached thereto. The presently disclosed technology may be mounted over the opening 21 of a container 2 to temporarily seal the container 2. Further, the presently disclosed technology includes a system that enables the composition of a headspace 211 within the container 2 to be modified and/or retained in a desired state after the container 2 has been sealed.

The seal liner or the induction seal liner 12 can be designed to react to and modify characteristics of the headspace 211 including, but not limited to, humidity, volatile compound concentrations, electrical charge, or magnetic polarization. Optionally, the active polymer component seal liner 12 reacts to the composition of the headspace 211 and thereby modifies the composition of the headspace 211. That is, the active polymer component seal liner 12 can react with or is otherwise triggered or activated by a selected material (e.g., by moisture) and in response releases an active component, optionally in gas or volatile form.

Alternatively, the active polymer component of the seal liner or the induction seal liner 12 may itself function as or release an active component without the need for any triggering or activation, e.g., in a dry environment. The active polymer component may be a film or sheet with a thickness that is determined based on the desired application. Optionally, the thickness of the active polymer component seal liner or the induction seal liner 12 may range from 0.1 mm to 1.0 mm, more preferably from 0.2 mm to 0.6 mm. In certain embodiments, the active polymer component seal liner or the induction seal liner 12 has a thickness of approximately 0.2 mm or 0.3 mm. The active polymer component seal liner or the induction seal liner 12 may be designed to act as an extended-release delivery system that is capable of modifying the composition of the headspace 211 after a desired time period. Thereby, maximizing the shelf life or viability of materials housed within the container 2.

To achieve the above-described functionality, the presently disclosed technology can include a mounting sheet 11 and a seal liner or an induction seal liner 12. Optionally, the mounting sheet 11 is a sacrificial panel of material that is designed to seal the opening 21 of the container 2 for a time before being pierced and discarded, or partially discarded, when a user accesses the material housed within the container 2 (FIG. 7).

The seal liner or the induction seal liner 12 can include or be formed of a quantity of active polymer compound that is attached onto and/or extends from a headspace-facing surface 112 of the mounting sheet 11. Further, a mounting portion 111 is positioned in between the seal liner or the induction seal liner 12 and an edge 113 of the mounting sheet 11, or exposed at or near the edge 113 of the mounting sheet 11 around a periphery of the seal liner 12 (see FIG. 5). As a result, the seal liner or the induction seal liner 12 can be retained within the container 2 by the mounting sheet 11 without preventing the mounting sheet 11 from being mounted over the opening 21 of the container 2.

Further, the mounting sheet 11 may be coupled or attached to a rim 22 of the container 2 that is disposed around the opening 21. The mounting portion 111 of the mounting sheet 11 is designed to be coupled to the rim 22 of the container 2 using at least one technique selected from the group including induction sealing, adhesives, chemical bonding, heat sealing, heat staking, and magnetic coupling.

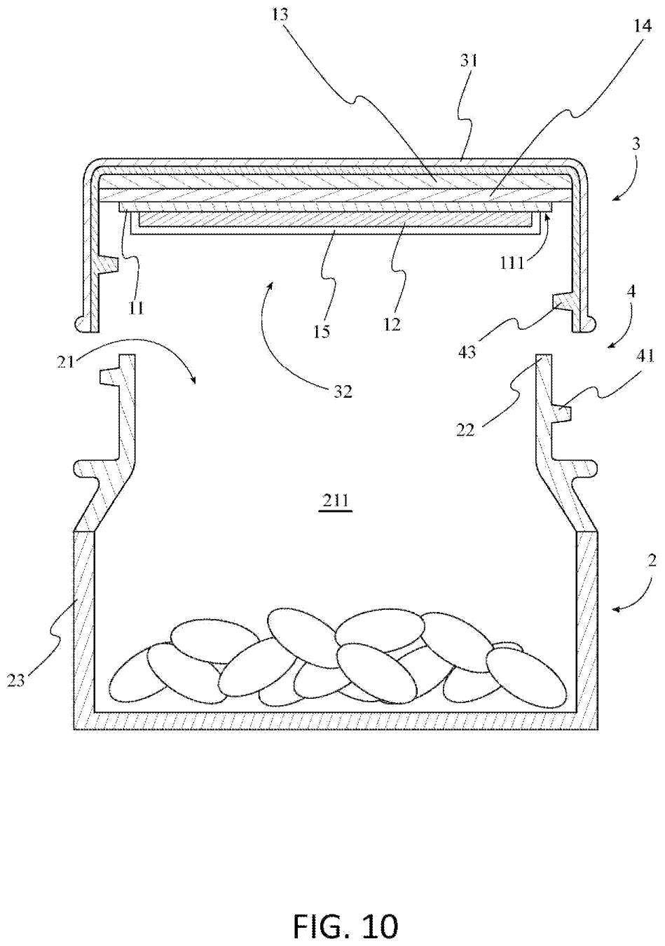

The presently disclosed technology may further include an extended-release coating 15 that is superimposed onto and/or covers at least a portion of the seal liner or the induction seal liner 12. The extended-release coating 15 is optionally a material that is designed to modulate the rate at which the active polymer compound of the seal liner or induction seal liner 12 reacts to the composition within the headspace 211 (FIG. 10).

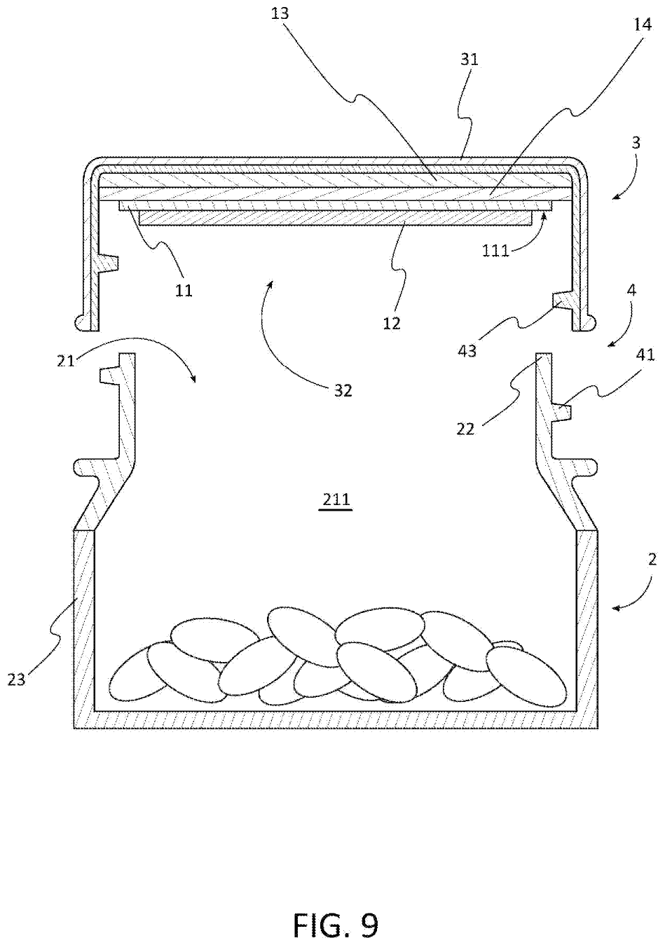

In one optional embodiment, the presently disclosed technology may further include a backing panel 13 that acts as a structural brace for the mounting sheet 11 (see FIG. 9). Additionally, the presently disclosed technology may further include a semipermanent mount 14 connected in between the backing panel 13 and the mounting sheet 11. The term “semipermanent mount” shall be used herein to refer to a connective material or structure that is destroyed during the process of coupling the mounting sheet 11 to the container 2. By way of nonlimiting example, the semipermanent mount 14 may be established through the use of a wax or adhesive material that is destroyed during induction heating, a magnetic coupling that degrades when exposed to heat, or a physical connection that is broken when the backing panel 13 is displaced relative to the mounting sheet 11. Accordingly, the semipermanent mount 14 is destroyed after the mounting sheet 11 is coupled to the rim 22. Further, the backing panel 13 is decoupled from the mounting sheet 11 when the semipermanent mount 14 is destroyed and an exterior surface of the mounting sheet 11 is exposed (see FIG. 7).

The presently disclosed technology may be utilized by employing a system for controlling the composition of the headspace 211 of the container 2 using a seal or an induction seal 1 with an active polymer component seal liner 12 included therein or attached thereto, wherein the active polymer component seal liner 12 includes a multiphase polymer composition. Specifically, the system can include the container 2, the seal or the induction seal 1 and a closure device 3. The closure device 3 can be a lid (e.g., a screw cap) that is mounted over the opening 21 of the container 2 and the seal or the induction seal 1 (see FIGS. 7, 9, and 11). The closure device 3 is moveable between an open position and a closed position with respect to the opening 21 of the container 2.

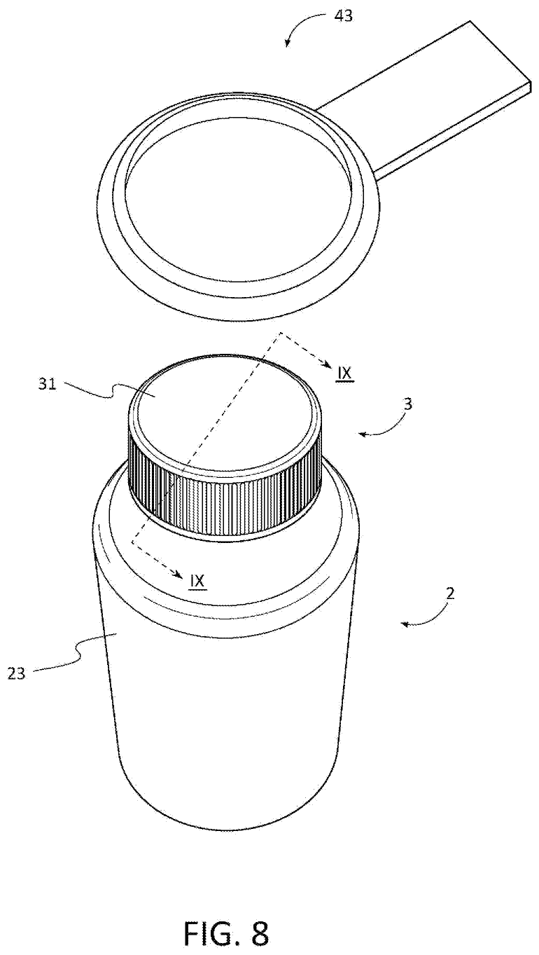

The closure device 3 can optionally include a lid body 31 and a container receptacle 32 or receiving area. The container receptacle 32 can extend into the lid body 31 so that the rim 22 of the container 2 may be inserted into the container receptacle 32, thereby enabling the closure device 3 to be mounted over the opening 21 of the container 2 and the seal or the induction seal 1. Further, the backing panel 13 can be mounted onto headspace-facing surface 112 of the closure device 3 within the container receptacle 32 such that the induction seal liner 12 is positioned opposite to the container facing surface, across the backing panel 13. An induction sealing device 43 can then be used to couple the mounting sheet 11 to the rim 22 (see FIG. 8).

In one optional embodiment, a method for employing the presently disclosed technology can begin by mounting the seal or the induction seal 1 within the container receptacle 32 of the closure device 3. The method can continue by coupling the mounting sheet 11 to the rim 22 of the container 2 with an induction sealing device. The induction sealing device 43 can cause the mounting sheet 11 to be bonded to the rim 22 of the container 2 such that the induction seal liner 12 is in fluid communication with an interior compartment of the container 2 through the opening 21. This enables the method to continue by modifying the chemical composition within the interior compartment with the induction seal liner 12. Finally, the method can optionally conclude when the composition of compounds within the interior compartment is enabled to achieve homeostasis after the induction seal 1 is removed.

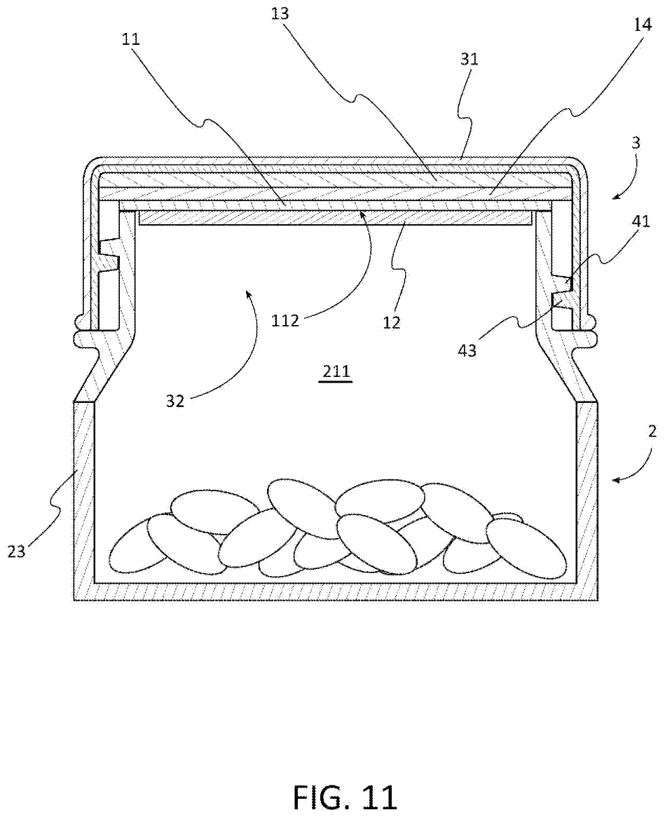

The system can further include a lid fastening mechanism 4 that is connected in between the closure device 3 and the container 2 (FIGS. 9 and 11). The lid fastening mechanism 4 is a device or structure that enables the closure device 3 to be detachably mounted over the opening 21 of the container 2 (e.g., threaded connectors, interlocking members, and clamping devices). The lid fastening mechanism 4 may further comprise a male threading 41 and a female threading 43. The male threading 41 is laterally connected around the container body 23 and the female threading 43 is laterally connected around the receptacle. As a result, the male threading 41 is able to engage into the female threading 43 when the closure device 3 is mounted over the opening 21 of the container 2.

FIGS. 7-9 illustrate various views of the container 2 in the form of a bottle, having an exemplary induction seal liner 12 secured thereto. While the bottle is used to illustrate one exemplary embodiment of a type of container that may be used in conjunction with the presently disclosed technology, other types of containers are also contemplated. The shape and geometry of the container or package in accordance with the presently disclosed technology are not limited. Likewise, the shape of the seal liner or the induction seal liner 12 is not limited, and will depend generally on the shape of the mouth or opening 21 of the container. For example, the seal liner or the induction seal liner 12 can be a generally flat or planar device having an outer periphery with a circular, oval, or rectangular shape, to seal a circular, oblong or rectangular opening or mouth of a container, respectively.

The optional embodiment shown in FIGS. 7-11 is cylindrical and thus has a round, unitary sidewall. However, containers according to the presently disclosed technology may be other shapes, e.g., rectangular cuboid, and thus have more than a single continuous (e.g., round) sidewall. As shown, e.g., in FIG. 9, the rim 22 that terminates and surrounds the opening 21 and has a continuous annular upper engagement surface extending from the opening 21 to an outer periphery of the rim 22.

A container optionally having an orifice reducer with one or a plurality of dispenser opening(s) (not shown) is also operable with the seal liner or the induction seal liner 12. The dispenser opening can be customized in shape and size for its particular use, depending on the product contained within the container for facilitating ordered and simple dispensing, such as condiments, (e.g., ketchup or mustard), or individual units or small numbers of units (e.g., medicinal tablets or capsules), or liquids (e.g., milk) or powders (e.g., spices) held by the container.

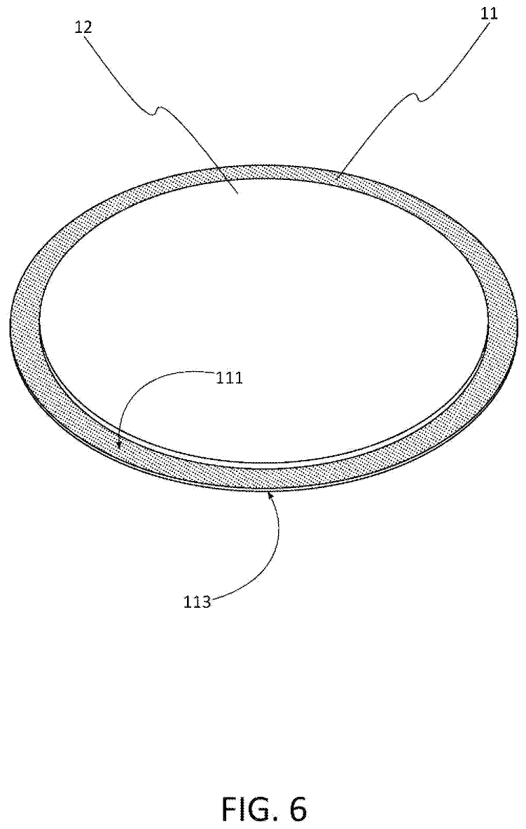

According to an optional embodiment, the container 2 incorporates a closure device 3. Illustrated in FIGS. 6-8 is a closure device 3 showing a cap body 31 as an exemplarily embodiment. The closure device 3 includes a removable seal or removable induction seal 1. As discussed above, a seal or an induction seal 1 is typically composed of a metallic compound 11, typically aluminum foil, though may be composed of other metallic foils. The metallic foil seal or the metallic foil induction seal 1 is disposed directly over the opening 21 or, in an optional embodiment, over or under an orifice reducer. The closure device 3 also can includes a cap body 31 that closes over and covers the aforementioned components (with or without additional interposed components).

The seal or the induction seal 1 is bonded to the circumferential edge or rim 22 of the mouth or opening 21 of the container 2, and the cap body 31 is closed thereover. The seal or the induction seal 1 has an underside that faces internally into the interior headspace 211 of the container 2, and a topside that faces toward the cap body 31. According to an optional embodiment, the seal liner or induction seal liner 12 is bonded by heat staking to the underside of the seal or the induction seal 1, optionally to the metallic foil 11.

According to one embodiment of the presently disclosed technology, the closure device 3 of a container 2 having a seal or an induction seal 1 includes a pulp backing that functions as the backing panel 13. A first surface of the pulp backing engages the underside of the cap body 31 and a wax layer 14 is connected in between the metallic foil layer 11 and a second surface of the pulp backing 13. Optionally, other layers as an alternative to wax are operable, which temporarily adhere the pulp backing 12 to the metallic foil 11.

The seal liner or the induction seal liner 12 affixed to the opening 21 of the container 2 will be typically removed from the opening 21 of the container 2 to access the contents of the container 2. It is contemplated that the flexible seal liner or the flexible induction seal liner 12 may be punctured over at least a section of the opening 21 of the container 2 thus providing access to the opening 21 and contents of the container 2. As an alternative to puncturing, the flexible seal liner or the flexible induction seal liner 12 may be removed from the opening 21 by peeling. The seal liner or the induction seal liner 12 can be peeled off using a sharp object, such as a knife, fork or container opener, or by fingernail. In another embodiment, the seal liner or the induction seal liner 12 has a pull tab (not shown) to facilitate removal of the liner 12, and the seal liner or the induction seal liner 12 can be removed from the opening 21 of the container 2 by grasping the pull tab (e.g., between the thumb and forefinger).

Optionally, the induction seal 1 includes a seam (not shown) which facilitates a user's removal of that portion of the induction seal 1 encompassed by the seam. Such removal may be achieved by peeling away that portion of the seal or the induction seal 1, by cutting along the seam or by puncturing that portion of the seal or the induction seal 1 and pulling it off the opening 21 of the container 2 or by removal by a pull tab. Optionally, the induction seal 1 and/or the induction seal liner 12 are generally circular and may include one or more tabs around the circumferential edge of the container opening.

The induction seal liner 12 (without or as part of an induction seal 1) may include other flexible barrier materials to provide a barrier to one or more atmospheric gases (e.g., oxygen or water vapor) adhered to or otherwise secured to at least a portion of the orifice reducer or to the metallic foil.

The following exemplary embodiments further describe optional aspects of the presently disclosed technology and are part of this Detailed Description. These exemplary embodiments are set forth in a format substantially akin to claims (each with numerical designations followed by a capital letter), although they are not technically claims of the present application. The following exemplary embodiments refer to each other in dependent relationships as “embodiments” instead of “claims.”
1A. A seal for the opening of a container, the seal including an active polymer component attached thereto.
2A. The seal of embodiment 1A, wherein the active polymer component is molded.
3A. The seal of embodiment 1A or 2A, wherein the active polymer component is heat staked to the seal.
4A. The seal of embodiment 1A, 2A, or 3A, wherein the seal or the active polymer component is induction sealed to the opening of the container.
1B. A method of extending the shelf life of contents of a container, the method comprising:
attaching a molded active polymer component to an induction seal; and
attaching the combined molded active polymer component and the induction seal to an upper rim of a container to enclose contents within the container.
2B. The method of embodiment 1B, wherein the molded active polymer component is separated from the container when the induction seal is separated from the container.
3B. The method of any one of embodiment 1B or 2B, wherein the combined molded active polymer component and the induction seal are discarded once the induction seal is separated from at least a portion of the upper rim of the container.
4B. The method of any one of embodiment 1B-3B, wherein the molded active polymer component is attached to the induction seal by heat staking.
5B. The method of any one of embodiment 1B-4B, wherein the molded active polymer component is attached to an interior surface of the induction seal.
1C. An active polymer component attached to a seal liner of a container, the active polymer component being attached to the seal liner by at least one of adhesive, heat sealing, and heat staking.
1D. The active polymer component of embodiment 1C, wherein the seal liner is an induction seal liner.

While the presently disclosed technology has been described in detail and with reference to specific examples thereof, it will be apparent to one skilled in the art that various changes and modifications can be made therein without departing from the spirit and scope thereof. It is understood, therefore, that the presently disclosed technology is not limited to the particular embodiments disclosed, but it is intended to cover modifications within the spirit and scope of the present presently disclosed technology.

1. An induction seal for a container, the induction seal comprising:
a mounting sheet configured to seal an opening of the container until a user accesses material housed in the container such that the mounting sheet is a sacrificial panel of material; and
an induction seal liner attached to a headspace-facing surface of the mounting sheet, the induction seal liner comprising an active polymer component including a multiphase polymer composition,
wherein a mounting portion is located or exposed between an outer edge of the induction seal liner and an outer edge of the mounting sheet.

2. The induction seal of claim 1, further comprising:
a backing panel; and
a semipermanent mount connected in between the backing panel and the mounting sheet.

3. The induction seal of claim 2, wherein the semipermanent mount is a layer of wax.

4. The induction seal of claim 2, wherein the semipermanent mount is an adhesive.

5. The induction seal of claim 1, wherein an extended-release coating is superimposed onto the induction seal liner.

6. The induction seal claim 1, wherein the induction seal liner has a thickness in the range of 0.1 mm to 1.0 mm.

7. The induction seal of claim 1, wherein the active polymer component includes at least one portion selected from the group consisting of a desiccant, an antioxidant agent, an antimicrobial agent, an odor reducing agent, and an anti-melanosic agent.

8. A system for controlling the chemical composition of a headspace of a container, the system comprising:
a container;
an induction seal;
an induction seal liner comprising an active polymer component including a multiphase polymer composition;
a closure device moveable between an open position and a closed position with respect to the container;
the induction seal comprising a mounting sheet, a backing panel, and a semipermanent mount;
the closure device comprising a lid body and a container receptacle;
the induction seal liner being attached onto a headspace-facing surface of the mounting sheet;
a mounting portion being positioned in between the induction seal liner and an edge of the mounting sheet;
the semipermanent mount being connected in between the backing panel and the mounting sheet;
the container receptacle extending into the lid body;
the backing panel being mounted onto a container-facing surface of the closure device;
an opening of the container being delineated by a rim of the container;
the container being inserted into the container receptacle;
the mounting portion being coupled to the rim; and
the induction seal liner being positioned over the opening.

9. The system of claim 8, wherein the induction seal liner is in fluid communication with an interior compartment of the container through the opening.

10. The system of claim 8, further comprising:
a lid fastening mechanism connected in between the closure device and the container.

11. The system of claim 10, further comprising:
the lid fastening mechanism comprising a male threading and a female threading, the male threading being laterally connected around the container, the female threading being laterally connected around the receptacle, the male threading being engaged into the female threading.

12. The system of claim 11, wherein the semipermanent mount is destroyed when the induction seal liner is coupled to the rim.

13. The system of claim 12, wherein the induction seal liner is secured to the rim of the container by at least one method selected from the group consisting of induction sealing, bonding with adhesives or lidding sealant, heat sealing, heat staking, and direct in-line melt adhesion.

14. The system of claim 13, wherein when disposed and secured over the opening of the container with an oxygen sensitive object in the container, the induction seal liner effectuates a reduction in oxygen concentration in the container as compared to the oxygen concentration in the container of the same type for the same period of time and under the same storage conditions without the induction seal liner.

15. The system of claim 14, wherein when disposed and secured over the opening of the container with an object inside, the induction seal liner effectuates a reduction in antimicrobial count on the object as compared to the same object stored in a container of the same type for the same period of time and under the same storage conditions without the induction seal liner.

16. The system of claim 15, wherein when disposed and secured over the opening of the container with an object in the container, the induction seal liner effectuates a reduction in moisture level in the container as compared to the moisture level in the container of the same type for the same period of time and under the same storage conditions without the induction seal liner.

17. The system of claim 16, wherein when disposed and secured over the opening of the container with an object in the container, the induction seal liner effectuates an increase in moisture level in the container as compared to the moisture level in the container of the same type for the same period of time and under the same storage conditions without the induction seal liner.

18. A method for controlling the chemical composition of compounds within a headspace of a container, the method comprising:
providing a container, a closure device, an induction seal, and an induction sealing device, the induction seal including an induction seal liner superimposed onto a mounting sheet, the induction seal liner comprising an active polymer component including a multiphase polymer composition;
inserting the induction seal into the closure device, wherein the induction seal liner is positioned opposite to the closure device;
mounting the closure device over an opening of the container, wherein the induction seal liner is in fluid communication with an interior compartment of the container through the opening;
coupling the mounting sheet to a rim of the container with the induction sealing device; and
modifying the chemical composition within the interior compartment with the induction seal liner;
wherein the chemical composition of compounds within the interior compartment is enabled to achieve homeostasis after the induction seal is removed; and
wherein the mounting sheet is configured to seal the opening of the container until a user accesses material housed in the container such that the mounting sheet is a sacrificial panel of material.

19. The method of claim 18, wherein the container is a pharmaceutical bottle.

20. The method of claim 18, wherein the closure device is a screw cap.

21. (canceled)

22. (canceled)

23. (canceled)
